(19) United States
(12) Patent Application Publication
(10) Pub. No.: US 2008/0316955 A1
(43) Pub. Date: Dec. 25, 2008

(54) Method and Apparatus for SDMA in a Wireless Network

(76) Inventor: Xiaoming Yu, Cupertino, CA (US)

Correspondence Address: XIAOMING YU;ADAPTWAVE TECHNOLOGIES INC, 903 SOUTH STELLING ROAD, CUPERTINO, CA, 95014, US

(21) Appl. No.: 11/765,440

(22) Filed: Jun. 19, 2007

(51) Int. Cl. H04B 7/204

(52) U.S. Cl. 370/319

(57) ABSTRACT

Techniques for enabling SDMA in a wireless network without using special SDMA related protocols in user terminals are disclosed. By emulating multiple non-SDMA base stations co-located at the same cell site, a base station is capable of communicating with regular user terminals on SDMA channels without requiring special SDMA protocols being implemented in the user terminals. FDMA, TDMA, and CDMA, or any combination of the three, may be used inside each of the emulated non-SDMA base station. SDMA, or any combination of SDMA, FDMA, TDMA, and CDMA, may be used among the emulated non-SDMA base stations. Coordination among the emulated non-SDMA base stations, as well as additional frequency domain, time domain, and code domain signal processing techniques, without the knowledge of the user terminals, may be performed by the SDMA base station to aid in more reliable communication of the SDMA channels.

### BACKGROUND

1. Field

This disclosure relates generally to wireless networking systems, and more specifically but not exclusively to technologies for enabling spatial division multiple access (SDMA) in a wireless network.

2. Description

Wireless communication systems are generally composed of one or more local central sites that serve a local area wherein a number of wireless users, fixed or mobile, are located. The local central sites are commonly referred to as base stations (BS) or access points (AP). In what follows, the term base station is used to describe the local central site. Base stations are equipped with transmitters and receivers through which wireless users with transmitter and receivers gain access to larger networks such as the public switching telephone network (PSTN) or the Internet. One of functions performed by a BS is to relay messages to and from wireless users all over the network. For multiple users to access the same AP or BS, traditional wireless systems use Frequency Division Multiple Access (FDMA), Time Division Multiple Access (TDMA), Code Division Multiple Access (CDMA), or any combinations of the three. FDMA works by allocating different frequencies to multiple users accessing a base station at the same time while TDMA works by allocating different time slots to multiple users accessing a base station at the same frequency. CDMA works by assigning multiple users accessing the same base station with unique time-frequency waveforms.

Spatial Division Multiple Access (SDMA) is a system access technology that allows a BS to provide multiple communication channels to multiple users by dividing the radio coverage into non-overlapping areas in the spatial domain. Each area may be assigned to one user so that the same frequency and time resource may be used by multiple users. In wireless communication systems that do not have the problem of multi-paths, such as satellite communications, SDMA is usually achieved through the use of directional beam pattern antennas. In wireless communications systems where multi-path is prevalent, one commonly used method to enable SDMA is to use an adaptive antenna system (AAS), or smart antenna system. AAS may include an antenna array that is capable of combining, constructively or destructively, multiple copies of the same signal received at each antenna. Multiple copies of the same desired signal received at each of the antenna may be combined constructively to enhance the desired signal while multiple copies of the same undesired signal received at each of the antenna may be combined destructively. The end result is an increase in signal-to-interference-noise ratio (SINR). In an SDMA system, each antenna receives multiple user signals. Each user is de-multiplexed from other users by treating other user signals as undesired signals through the aforementioned array processing, or by jointly detecting users on the same SDMA channel. SDMA may be regarded as a fourth type of multiple access method. Multiple accesses may thus be achieved in four domains: frequency, time, code, and space. In addition, SDMA may be combined with any or all of the other three types of multiple access method.

Because SDMA increases the capacity of a wireless system as the same frequency, time, and code resources may be reused for multiple users, SDMA has become very popular in today's broadband wireless systems, especially with the increasing demand for data throughput.

To enable SDMA, a wireless system usually requires special protocols and features related to SDMA that are not required in a conventional non-SDMA system. Examples of SDMA protocols and features may include:
Control messages to instruct each SDMA user to use different pilot or training sequence to aid the base station in spatial de-multiplexing,
Control messages to instruct each SDMA user to perform channel sounding in which the user transmits training sequence(s) to aid the base station to estimate channel,
Channel allocation messages to instruct SDMA users to use SDMA channels through allocating the same channel in frequency and time domain multiple times,
Special channel structure such as SDMA preambles to aid the base station in performing spatial multiplexing.

Due to the large volume of user terminals and consumer's sensitivity to the price of user terminals, it is highly desirable to keep the user terminal simple and low cost. The special SDMA protocols and features are usually complex and are not needed in a system that does not support SDMA. In addition, they may be required to be implemented not only on the access network side but also the user terminal side.

One example is IEEE802.16 standard. IEEE 208.16, commonly known as World Interoperability for Microwave Access (WiMAX), is a broadband wireless standard described in “Air Interface for Fixed Broadband Wireless Access Systems,” IEEE STD 802.16-2004, October, 2004, and “Air Interface for Fixed and Mobile Broadband Wireless Access Systems,” IEEE P802.16e/D12, February, 2005. SDMA is one of access methods supported by the WiMAX standard. To support and enable SDMA, the IEEE 802.16 standard specifies a number of features and protocols related to MS and SDMA, such as MS zone, SDMA pilots, Downlink Information element for SDMA (MS_SDMA_DL_IE), and Uplink information element for SDMA (MS_SDMA_UL_IE). MS zone includes channels that have a special structure including MS preambles and SDMA pilots. AAS_SDMA_DL_IE are control messages that a base station uses to allocate SDMA channels to users in the downlink. MS_SDMA_UL_IE are control messages that a base station uses to allocate SDMA channels to users in the uplink. A WiMAX network with some or all of these features and protocols enabled on both base stations and user terminals will be able to support SDMA.

IEEE 802.16 is a standard that has many options. To facilitate inter-operability between products from different vendors, the WiMAX Forum, which is a consortium of members consisting of companies and parties who are interested in promoting WiMAX, has devised a list of the features (called mobile system profile) that the members have agreed to implement. The most recent system profile is described in WiMAX Forum Mobile System Profile: Release 1.0 Approved Specification, WiMax Forum, Apr. 12, 2007. To keep the user terminals simple, the advanced AAS and SDMA related features, such as AAS zone and SDMA pilots, which are listed under Section AAS, are described as features not required to be implemented in this profile,. As a result, the majority of the user terminals produced for WiMAX will not support AAS and SDMA features. This will make it very difficult to use SDMA in a WiMAX network. Even if the AAS and SDMA features are implemented in base stations of a WiMAX network, it may still not be possible to use SDMA as specified in the IEEE 802.16 standard since there will not be enough user terminals to support the AAS and SDMA features.

### BRIEF DESCRIPTION OF THE DRAWINGS

The features and advantages of the disclosed subject matter will become apparent from the following detailed description of the subject matter in which:

FIG. 1 illustrates a block diagram of an example wireless network system, according to an embodiment of the subject matter disclosed in the present application;

FIG. 2 illustrates an example base station in communication with a plurality of user terminals, according to an embodiment of the subject matter disclosed in the present application;

FIG. 3 illustrates a block diagram of an example base station that supports multiple user terminals on SDMA channels without using special SDMA related protocols, according to an embodiment of the subject matter disclosed in the present application;

FIG. 4 illustrates an example SDMA channels in a WiMAX communication system, according to an embodiment of the subject matter disclosed in the present application;

FIG. 5 illustrates a flow diagram of an example process for supporting multiple user terminals on SDMA channels without using special SDMA related protocols in a wireless network, according to an embodiment of the subject matter disclosed in the present application; and

FIG. 6 illustrates a flow diagram of an example process for supporting multiple user terminals on SDMA channels without using special SDMA related protocols in a WiMAX network, according to an embodiment of the subject matter disclosed in the present application.

### DETAILED DESCRIPTION

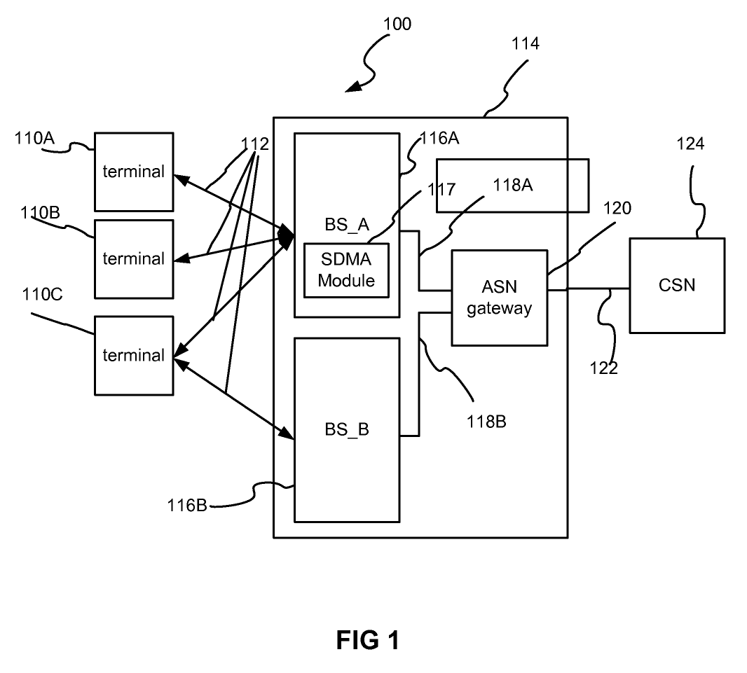

FIG. 1 illustrates a block diagram of an example wireless network 100 where an embodiment of the present invention may be implemented. The wireless network 100 may have a plurality of user terminals such as terminals 110A, 110B, and 110C. A user terminal may be a mobile station (MS) or a non-mobile subscriber station (SS). In what follows, the term user terminal is used to describe both MS and SS. User terminals may thus include a cell phone, a personal directory assistant (PDA), a computer, etc. The user terminals in wireless network 100 may or may not have implemented SDMA protocols and features.

The wireless network 100 may also include one or multiple access service networks (ASN) 114 and one or multiple core service networks (CSN) 124. The ASN 114 may have different names in different wireless systems. One such commonly used alternative name is radio access network (RAN). It provides network functions needed to enable a wireless user terminal with radio access. It includes functions such as connectivity with user terminals, radio resource management, relay functions, etc. ASN 114 may comprise one or more base stations, such as BS's 116A and 116B, and one or more ASN gateway(s) such as ASN gateway 120. The ASN gateway 120 may have different names in different wireless systems. One such commonly used name is base station controller (BSC). An ASN gateway aggregates BS traffic and interfaces with CSN. CSN may have different names such as core network (CN) in different wireless standard. In addition, the ASN gateway may provide radio resource control and management as well as mobility management functions. A BS is a generalized equipment for providing connectivity, management, and control of user terminals. A BS is a network element providing an air interface between user terminals (e.g., terminal 110A, 110B, and 110C) and an access service network (ASN) (e.g., ASN 114). A BS may have a single sector or multiple sectors. In a single sector BS, it usually uses omni-directional antenna to cover its coverage area. In a multi-sector BS, the BS's coverage area is divided into radial sectors with directional antenna covering each sector. For example, three 120 degree antennas installed at a BS forms a 3-sector BS. A BS may connect to an ASN gateway. In FIG. 1, BS 116A and BS 116B are connected to ASN gateway 120 through their respective links 118A and 118B. ASN gateway 120 may be coupled with a connectivity service network 124 through a wired or wireless link 122.

CSN may perform a set of network functions that provide network connectivity services to a wireless subscriber. CSN may comprise network elements such as routers, authentication, authorization, and accounting (AAA) proxy/servers, user databases, etc.

A user terminal may be coupled to one or several BSs through wireless air link 112. According to one embodiment shown in FIG. 1, terminal 110A and terminal 110B are coupled to BS 116A while terminal 110C is coupled to both BS 116A and BS 116B.

At least one BS (e.g., BS 116A and/or BS 116B) may implement SDMA according to an embodiment of the subject matter disclosed in this application. A BS that implements SDMA according to an embodiment of the subject matter disclosed in this application will be referred to as SDMA BS hereinafter. A BS that does not have SDMA capability, or a BS that implements SDMA other than an embodiment of the subject matter disclosed in this application, will be referred to as conventional BS hereinafter. A BS without SDMA capability will be referred to as non-SDMA BS hereinafter. A conventional BS may thus include a non-SDMA BS, or a BS that implements SDMA through special SDMA protocols and features.

Both SDMA BS's and conventional BS's including non-SDMA BS's may include BS's that have multiple-input-multiple-output (MIMO) capability. MIMO systems use both multiple antennas at the transmitter and receiver. Performance of wireless communication may be impaired by multi-path fading. Multi-path occurs when the transmitted signal arrives at an intended receiver through different paths. A MIMO system exploits the multi-path signals in the spatial domain in addition to the time and frequency domains which are domains usually used in a single antenna system. A MIMO system increases the spatial diversity up to M×N times, where M and N are the number of transmit and receive antennas respectively. The increase in spatial diversity may be used to increase the coverage and/or data throughput of a wireless system.

For wireless network 100 as shown in FIG. 1, BS 116A is an SDMA BS. BS 116A includes an SDMA module 117 that implements SDMA according to an embodiment of the subject matter disclosed in this application. Terminals 110A, 110B, and 110C, even if they do not implement SDMA protocols and features, may still access the network through BS 116A using SDMA. In fact terminals 110A, 110B, and 110C do not need to know they are accessing the network using SDMA.

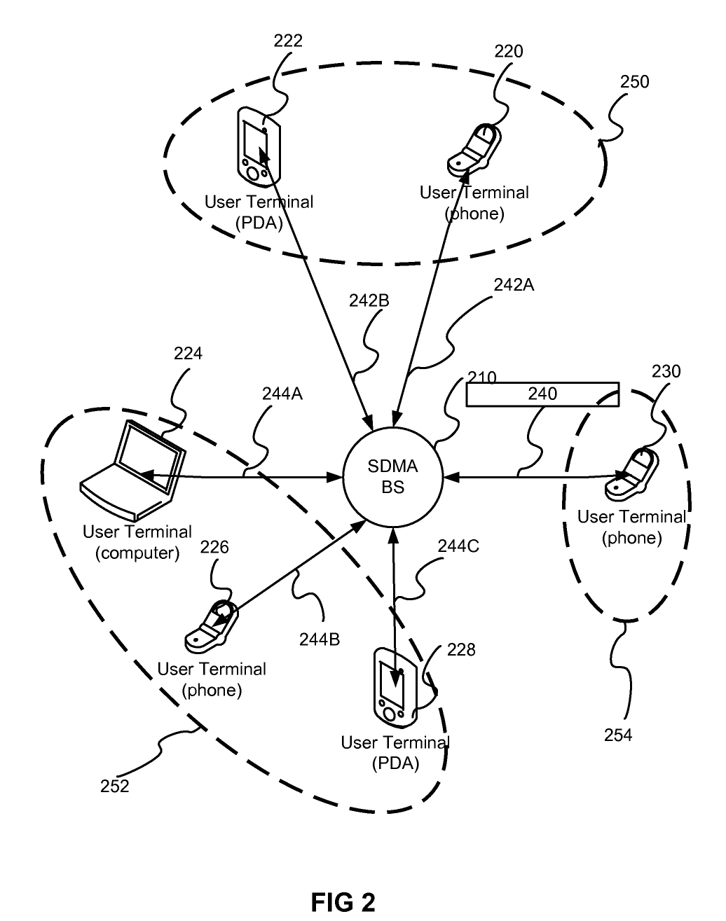

FIG. 2 illustrates an example SDMA BS 210 in communication with a plurality of user terminals wherein the SDMA BS emulates multiple non-SDMA BS's, or multiple non-SDMA sectors if it is a sectorized SDMA BS, that are co-located at the same cell site. Three emulated non-SDMA BS's 250, 252, and 254 are illustrated in FIG. 2. The SDMA BS 210 is in communications with a plurality of user terminals including phones, PDAs, and computers labeled as user terminals 220, 222, 224, 226, 228, and 230. User terminals communicate with BS 210 through one of its emulated non-SDMA BS's. As illustrated in FIG. 2, user terminals 220 and 222 communicate with SDMA BS 210 through wireless links 242A and 242B provided by emulated non-SDMA BS 250. User terminals 224, 226 and 228 communications with SDMA BS 210 through wireless links 244A, 244B, and 244C provided by emulated non-SDMA BS 252. In the same fashion, user terminal 230 communicates with SDMA BS 210 through wireless link 240 provided by emulated non-SDMA BS 254. A user terminal communications to and from the SDMA BS 210, including the downlink messages and signals which the user terminal receives from BS 210 and uplink messages and signals which the user terminal sends to BS 210, as if the user terminal were communicating with a non-SDMA BS located at the same cell site. Hence, no special additional features are required of a user terminal because to the user terminal, it communicates with a regular conventional BS although this regular conventional BS is emulated by SDMA BS 210. Therefore, any regular user terminal that is capable of communicating with a regular conventional BS is able to communicate with SDMA BS 210.

Although the user terminals might not be aware of the SDMA nature of their access to a wireless network, SDMA BS 210 is fully aware of SDMA and may need to coordinate multiple access among emulated non-SDMA BS's. Within each of the emulated non-SDMA BS's, multiple access is supported without using SDMA. An emulated non-SDMA BS may provide multiple access by user terminals through one or a combination of FDMA, TDMA, and CDMA methods. In FIG. 2, for example, the multiple access capability of emulated non-SDMA BS 252 may be achieved by using FDMA for wireless link 244A, TDMA for wireless link 244B, and CDMA for wireless link 244C. In a similar fashion, the multiple access capability of emulated non-SDMA BS 250 may be achieved by using a combination of FDMA, TDMA, and CDMA for wireless link 242A and a different combination of FDMA, TDMA, and CDMA for wireless link 242B. Among the emulated non-SDMA BS's, such as emulated BS's 250, 252, and 254, however, SDMA may be supported so that they may use air link that are partially, or completely overlap in frequency, time, and code domains. For example, in FIG. 2, user terminal 230 which is supported by emulated non-SDMA BS 254, user terminal 224 which is supported by emulated non-SDMA BS 252, and/or user terminal 220 which is supported by emulated non-SDMA B S250 may access BS 210 use SDMA, i.e., wireless links 240, 244A, and 242A may partially or completely overlap in frequency, time, and/or code domains.

Additionally, service areas of emulated BS's 250, 252, and 254 may also overlap. In overlapped coverage areas of the emulated BS's, the SDMA BS 210 may use spatial multiplexing and de-multiplexing technologies to separate their supported communication channels in spatial domain. Channel separating, or de-multiplexing may be achieved by equipping an SDMA BS with an adaptive antenna system that includes an array of antennas with multiple receivers and transmitters, and by adding an SDMA module capable of spatial domain processing. The capability of antenna arrays to separate signals in the spatial domain is well known in the signal processing community. One such an adaptive antenna system is described in “Digital Beamforming in Wireless Communications,” by John Litva, published by Artech House in 1996.

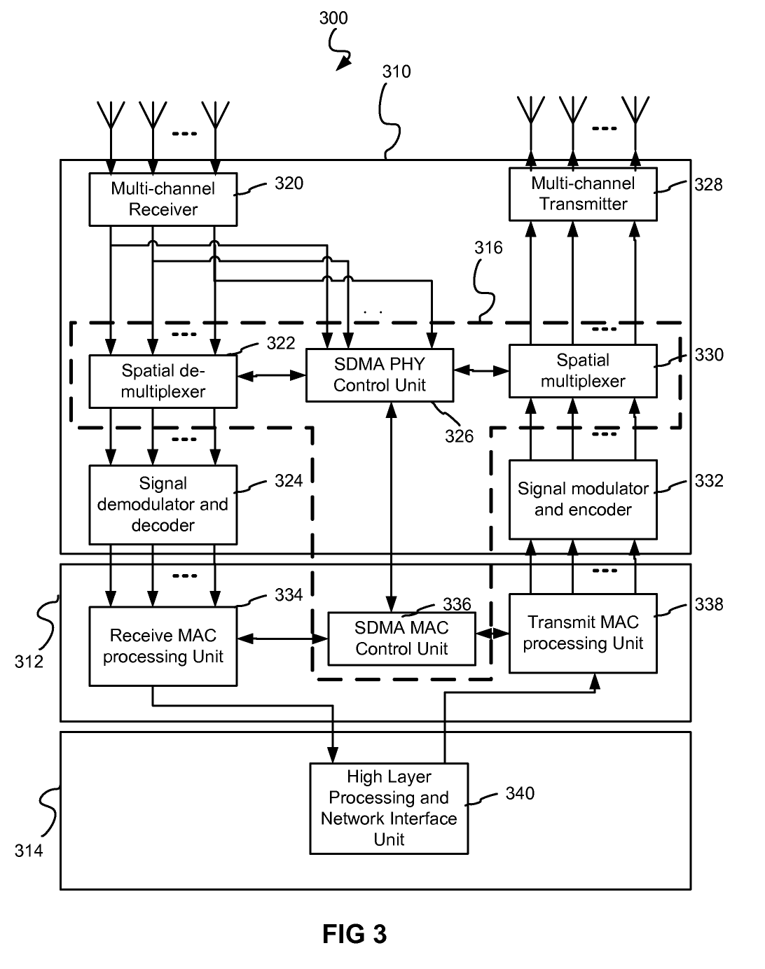

FIG. 3 illustrates a block diagram of an example SDMA BS 300, or a sector of a SDMA BS if it is a sectorized BS, in which an embodiment of the subject matter disclosed in this application may be implemented. BS 300 includes multiple layers as does a conventional BS. For the purpose of illustration, only a few components in the multiple layers are shown to describe the subject matter disclosed herein. SDMA BS 300 includes a physical layer (PHY) 310 and a multiple access layer (MAC) 312. Layers higher than PHY and MAC are put together in as a high layer 314. Functions performed by high layer 314 include mostly processing of information in data link layer and above as well as network interfacing functions.

PHY 310 receives and transmits signals. It includes a receive section which comprises a multi-channel receiver 320, a spatial de-multiplexer 322, and a signal demodulator and decoder 324. Multi-channel receiver 320 receives multiple user signals from an antenna array, conducts receive processing of single antenna signal such as amplification, filtering, down conversion, analog-to-digital conversion, etc. The spatial de-multiplexer 322 separates multiple user signals in the spatial domain through methods such adaptive array processing whenever needed. With the separation capability of spatial de-multiplexer 322, multi-channel receiver 320 will be able to receive signals from multiple user signals using a single antenna array. Signal demodulator and decoder 324 removes signal modulation and coding on each user's signal to recover the original data transmitted by user terminals.

PHY 310 also includes a transmit section which comprises a multi-channel transmitter 328, a spatial multiplexer 330, and a signal modulator and encoder 332. The signal modulator and encoder 332 encodes each user's data and modulates the data to make it suitable for conversion into radio frequency (RF). The spatial multiplexer 330 multiplexes each user signal on to the input of the multi-channel transmitter 328. It may also conduct spatial processing such as adaptive array transmit processing to enable easy reception of each user's signal by a user terminal after they are transmitted from the antenna array. Spatial multiplexer 330 enables multiple emulated non-SDMA BS's signals to be transmitted through a single antenna array. The multi-channel transmitter 328 carries out transmit functions such as digital-to-analog-conversion, filtering, up-conversion, signal amplification, etc. After performing these transmit functions, the multi-channel transmitter 328 transmits RF signals through an antenna array to user terminals. The multiple-channel receiver 320 and the multiple-channel transmitter 328 may share the same antenna array.

PHY 310 may also include an SDMA PHY control unit 326 which conducts computing and signal processing needed for controlling spatial multiplexing and de-multiplexing. SDMA PHY control unit 326 may obtain control information for spatial multiplexer 322 from signals received from multi-channel receiver 320.

MAC 312 may include a receive MAC processing unit 334 and a transmit MAC processing unit 338 which carry out MAC message processing for the receive and transmit sides, respectively. MAC 312 may also include an SDMA MAC control unit 336 which control other components in the MAC layer and make decisions such as user scheduling in the MAC layer. The SDMA MAC control unit 336 may work in conjunction with the SDMA PHY control unit 326 to jointly make decisions related to SDMA control such as user scheduling.

In the example SDMA BS 300 shown in FIG. 3, components that perform functions to enable SDMA according to an embodiment of the subject matter disclosed in this application are grouped together into a SDMA module 316. The SDMA module 316 spans across both the PHY layer 310 and MAC layer 312. It may comprise spatial de-multiplexer 322, spatial multiplexer 330, SDMA PHY control unit 326, and SDMA MAC control unit 336. The SDMA module 316 carries out signal analysis of output signals from multi-channel receiver 320, conducts spatial signal processing, frequency and/or time domain signal processing if needed, multiplexing and de-multiplexing user signals. Such functions performed by the SDMA module enable SDMA by user terminals without the user terminals even knowing that they are accessing the wireless network using SDMA. The signal received by the multi-channel receiver 320 from each antenna comprises a sum of multiple user signals. The SDMA module 316 performs spatial domain processing to separate each user signal from others.

SDMA module 316 may also conduct the analysis of the suitability of performing SDMA. Depending on the capability of SDMA module 316 and factors such as the number of antennas used, there may be situations in which separation of one user signal from others in spatial domain is not reliable. One example is when one user's signal power is so high that it completely drowns out other user signals. In this case, it is desired that such a high power user is not allocated on SDMA with other users, or is allocated on SDMA with other users that have similarly high signal powers. SDMA module 316 may conduct the analysis of the suitability of performing SDMA, scheduling SDMA users through SDMA MAC control unit 336 only when the conditions are favorable to SDMA.

In wireless communications, user terminals communicate with base stations through wireless channels. Communication between a user terminal and a base station can be generally characterized into three types: unicast, broadcast, and multicast. In a unicast communication, there is one-to-one relationship between the transmitter and the receiver. In broadcast communication, the transmitter sends signals/messages directed to everyone. Multicast communication is similar to broadcast communication, the difference is that signals/messages are sent to a set of selected receivers rather than everyone. Information and messages related to network parameters, user terminal synchronization, such as pilots, synchronization channels, and user terminal paging channels, are usually broadcast or multicast while user traffic are usually unicast.

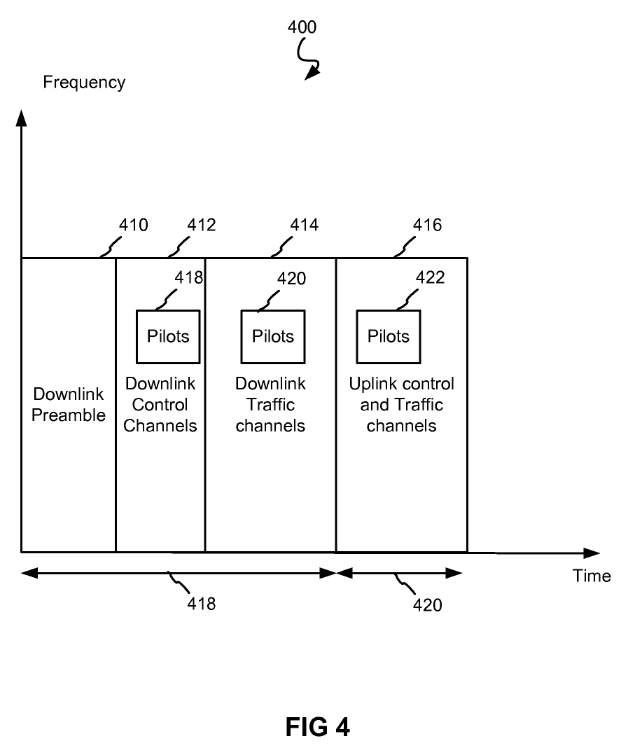

FIG. 4 illustrates an example wireless channels 400 used in a WiMAX system, according to an embodiment of the subject matter disclosed in the present application. In a WiMAX system, available time is divided into frames, each frame comprises a downlink (from a BS to user terminals) sub-frame and an uplink (from user terminals to a BS) sub-frame, used for downlink and uplink communication, respectively. In FIG. 4, wireless channels 400 are shown having a downlink subframe 418 and an uplink sub-frame 420. Channels 400 are for time-division duplexing (TDD). In the case of frequency-division duplexing (FDD), the uplink subframe 420 will be on a different frequency band. Subframe 418 includes a downlink preamble 410 which is a channel with a predefined data sequence. A user terminal may use a preamble to synchronize with the base station that transmits the preamble. The downlink preamble 410 includes information such as the identification (ID) number of the base station. Additionally, subframe 418 includes downlink control channels 412 which inform user terminals allocation of user traffic included in downlink traffic channels 414 and uplink control and traffic channels 416. Furthermore, subframe 418 includes downlink traffic channels 414 which the base station uses to send user terminals data traffic. The uplink sub-frame 420 includes uplink control and traffic channels which the user terminals use to send the base station control information as well as data traffic. Downlink preamble 410 and downlink control channels 412 are broadcast/multicast channels while downlink traffic channels 414 and the uplink control and traffic channels may be unicast channels.

There are also training sequences or pilots 418, 420, and 422 in most of the channels as illustrated in FIG. 4. Training sequences or pilots are pre-defined data or signal sequences that a BS or a user terminal uses to aid in estimating wireless channels in which the BS or the user terminal is. Additionally, training sequences or pilots help with signal demodulating and decoding.

Since an SDMA BS emulates multiple co-located non-SDMA BS's, signals to and from these emulated BSs are likely to collide, or interfere with each other. Although user terminals accessing a SDMA base station may not be aware of the nature of SDMA, the SDMA base station is fully aware of SDMA. The SDMA base station may use spatial processing techniques such as those disclosed in the present application to separate them. In many situations, it is also desirable for the SDMA BS to coordinate among its emulated non-SDMA BS's to facilitate the use of additional frequency domain, time domain, or code domain processing techniques. These techniques may be used alone, combined together, or used together with the spatial domain techniques, to make multiple access channels of the emulated non-SDMA BS's work more reliably. For example, the aforementioned adaptive array processing may be less effective for downlink broadcast or multicast channels when the array need to focus energy on multiple user terminals simultaneously. To make the downlink broadcast and multicast channels more reliable, the SDMA BS may choose to place the broadcast and multicast channels of each of the emulated BS's on different frequency band so they do not overlap in frequency domain. User terminals associated with different emulated non-SDMA BS's can detect their desired downlink broadcast and multicast channels through frequency domain filtering. Even in the situation of unicast channels, the SDMA BS may coordinate among its emulated BS's to facilitate additional signal processing in frequency, time, or code domains to make communication more reliable. In what follows, several embodiments of the subject matter disclosed in the present application using these techniques are described.

In one embodiment, channels that carry information conveyed through a set of codes or a data sequence may be so chosen that they are different in one or multiple of the emulated non-SDMA BSs of an SDMA BS. For example, in the example WiMAX channels 400 in FIG. 4, the SDMA BS may assign different preamble sequences to one or multiple of its emulated non-SDMA BS's. This makes it easier for a user terminal to listen to one of the preambles and associate it with one of the emulated BS in the SDMA BS using methods such as correlation.

In another embodiment of the subject matter disclosed in the present application, channels may be allocated so that they are on different frequency bands for one or multiple of the emulated non-SDMA BSs of an SDMA BS. For example, in the example WiMAX channels 400 in FIG. 4, the SDMA BS may assign different frequencies to the downlink control channels of different emulated non-SDMA BS's. This makes it easier for a user terminal to listen to one of the downlink control channels and decode control information and messages associated with one of the emulated non-SDMA BS in the SDMA BS using frequency domain filtering.

In another embodiment of the subject matter disclosed in the present application, channels may be allocated so that they are not overlapping in time in one or multiple of the emulated non-SDMA BSs of an SDMA BS. For example, in the example WiMAX channels 400 in FIG. 4, an SDMA BS may assign uplink control channels of one or multiple of its emulated non-SDMA BS's to not overlapping in time. This makes it easier for the base station to decode the uplink control information and messages associated with one of the emulated non-SDMA BS's in the SDMA BS.

Yet In another embodiment of the subject matter disclosed in the present application, one or multiple of pilots, which are predefined training sequences, my be chosen to be different for channels in one or multiple of the emulated non-SDMA BS's of an SDMA BS. This makes it easier for a user terminal or a base station to estimate its channel when demodulating and decoding the signals on SDMA channels.

Although example embodiments of the disclosed subject matter are described above using examples of preamble, downlink control channel, uplink control channel, and pilots, persons of ordinary skill in the art will readily appreciate that many other methods of implementing the disclosed subject matter may alternatively be used. In addition, the methods of implementing the disclosed subject matter may be changed, or combined. For example, the preambles may be chosen to be placed on different frequency bands rather than using different data sequences, or the preambles may be chosen to be placed on different frequencies as well as using different data sequences.

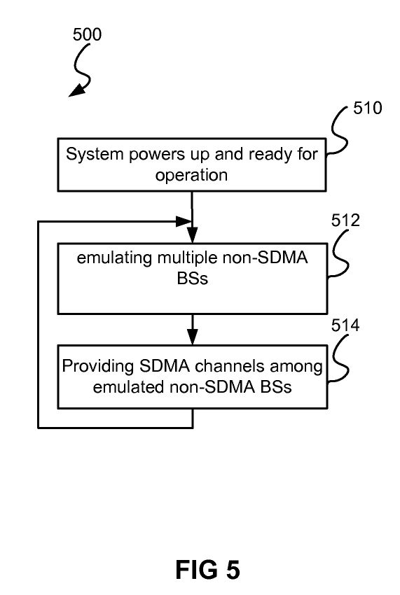

FIG. 5 illustrates an example process 500 for enabling SDMA in a wireless network, according to an embodiment of the subject matter disclosed in this application. Process 500 may be carried out by an SDMA BS, or a sector of the SDMA BS if it is multi-sector BS.

Process 500 starts with operation 510 during which a wireless system powers up and makes itself ready for operation. Also at this operation, a BS is allocated to support SDMA when communicating with a plurality of user terminals. Subsequently, the SDMA BS performs operation 512 in which it emulates multiple co-located non-SDMA BSs, or multiple non-SDMA sectors if it is a sectorized SDMA BS. To a user terminal, the channels from the SDMA BS are just as if they were received from multiple non-SDMA BSs located at the same cell site. Each user terminal communicates with the SDMA BS through one of its emulated non-SDMA BS. Whenever needed, the SDMA BS performs operation 514 in which it allocates SDMA channels among one or multiple emulated BS's. The SDMA base station may use spatial processing techniques such as those disclosed in the present application to separate them. Additionally, the SDMA BS may coordinate among its emulated non-SDMA BS's to facilitate the use of additional frequency domain, time domain, or code domain processing techniques. After operation 514, process 500 returns to operation operation 512.

Process 500 also applies to BSs with MIMO capability. To support MIMO communication, among the multiple emulated non-SDMA BSs, some or all of them may be base stations that support MIMO communication.

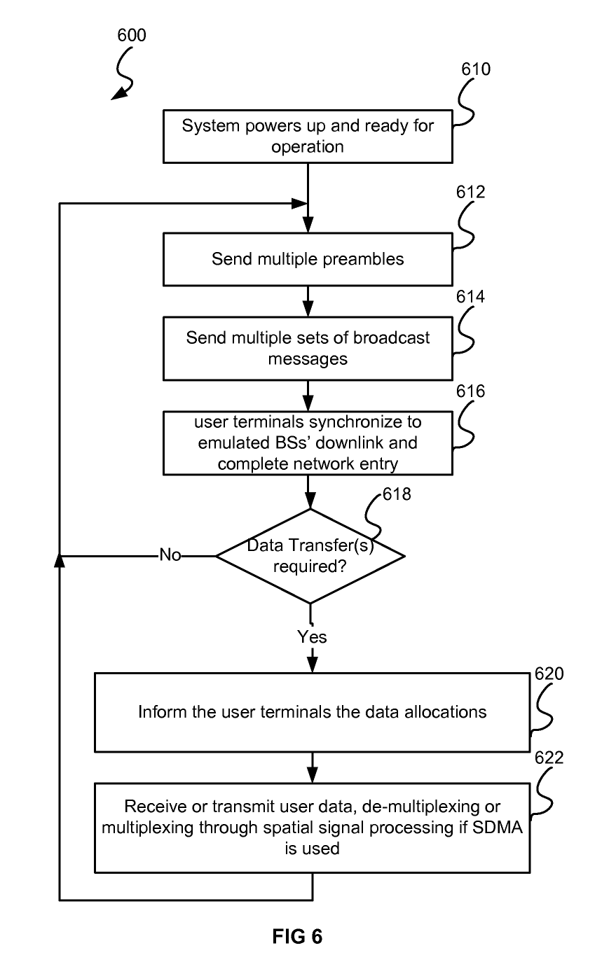

FIG. 6 illustrates an example process 600 for enabling SDMA in a WiMAX network, according to an embodiment of the subject matter disclosed in this application. Process 600 may be carried out by an SDMA WiMAX BS, or a sector of the SDMA BS if it is multi-sector WiMAX BS.

Process 600 starts with operation 610 during which a WiMAX SDMA base station powers up and makes itself ready for operation. Subsequently, the SDMA BS performs operation 612 in which it sends out multiple preambles. The preambles may be allocated on different frequency segments or bands to facilitate reception by user terminals. The SDMA BS then performs operation 614 in which it sends out multiple sets of broadcast channels including downlink control channels. The downlink control channels may be on different frequency bands to facilitate reception by user terminals. The SDMA BS has thus emulated multiple non-SDMA BSs' preambles and downlink broadcast channels. User terminals in the SDMA base station coverage area synchronize to the emulated BSs' downlink and complete network entry in operation 616. A user terminal registers and associates with a BS through the network entry process. In operation 618, the SDMA base station decides if there are data transfer(s) required. It goes back to operation 612 if there is no data transfer needed, otherwise it informs the user terminals the data allocations in operation 620 so the user terminals understand where to transmit and/or receive their corresponding data messages. Operation 622 multiplex/de-multiplex the user signals. The allocation in operation 620 may be multiple access without SDMA, in which case frequency domain, time domain, or code domain multiple access processing is need in operation 622 to multiplex and de-multiplex user signals. If SDMA allocation is used, additional spatial domain processing may be need in addition to the time/frequency/code domain processing in operation 622. Process 600 also applies to BSs with MIMO capability. To support MIMO communication, data allocation in operation 620 may be on MIMO channels.

Although example embodiments of the disclosed subject matter are described with reference to block and flow diagrams in FIGS. 1-6, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A method for supporting SDMA in a wireless communication network, comprising:
allocating at least one base station for communicating with a plurality of user terminals;
emulating multiple co-located non-SDMA base stations in said at least one base station; and
allocating SDMA communication channels for emulated said non-SDMA base stations in said at least one base station.

2. The method of claim 1, wherein said plurality of user terminals comprise a user terminal that does not implement any SDMA feature.

3. The method of claim 1, wherein said base station further allocates non-SDMA communication channels comprises unicast channels, broadcast channels, and multicast channels for emulated said non-SDMA base stations.

4. The method of claim 3, wherein allocating said non-SDMA communication channels comprises allocating said unicast, broadcast, and multicast channels in at least one of different domains for different emulated non-SDMA base stations to avoid overlapping of channels among said emulated non-SDMA base stations, said domains including time domain, frequency domain, and code domain.

5. The method of claim 3, wherein allocating said non-SDMA communication channels further comprises allocating unicast channels of different emulated non-SDMA base stations in different time, and/or different frequencies.

6. The method of claim 3, wherein allocating said non-SDMA communication channels further comprises allocating broadcast channels, and/or multicast channels of different emulated non-SDMA base stations in different frequencies.

7. The method of claim 3, wherein allocating said non-SDMA communication channels further comprises allocating broadcast channels, and/or multicast channels of different emulated non-SDMA base stations in different codes.

8. The method of claim 1, further comprising performing spatial separation among said emulated non-SDMA base stations.

9. The method of claim 1, wherein the wireless networking system comprises a WiMAX networking system.

10. An apparatus for supporting SDMA in a wireless communication network, comprising:
a multi-channel receiver to receive a first set of signals from a plurality of user terminals and to perform at least one of amplification, down-sampling, or analog-to-digital conversion of the first set of signals;
means for emulating multiple co-located non-SDMA base stations, each emulated non-SDMA base station communicating with one or more of said plurality of user terminals in the substantially same way as a conventional non-SDMA base station communicates with the one or more of said plurality of user terminals, each emulated non-SDMA base station processing signals derived from the first said of signals; and
a multi-channel transmitter to transmit a second set of signals to said plurality of user terminals, the second set of signals including signals sent by said emulated non-SDMA base stations to said plurality of user terminals.

11. The apparatus of claim 10, wherein said means for emulating multiple co-located non-SDMA base stations comprises:
de-multiplexing means for spatially de-multiplexing the first set of signals; and
multiplexing means for spatially multiplexing signals that said emulated non-SDMA base stations send to said plurality of user terminals to produce the second set of signals.

12. The apparatus of claim 11, wherein said means for emulating multiple co-located non-SDMA base stations further comprises:
de-multiplexing means for de-multiplexing the first set of signals in at least one of different domains, said domains including time domain, frequency domain, and code domain; and
multiplexing means for multiplexing signals that said non-SDMA base stations send to said plurality of user terminals to produce the second set of signals, in at least one of different domains, said domains including time domain, frequency domain, and code domain.

13. The apparatus of claim 11, further comprising:
a signal demodulator and decoder to demodulate and decode said de-multiplexed signals;
processing means for processing messages received from said plurality of user terminals and messages sent to said plurality of user terminals by said emulated non-SDMA base stations; and
a signal modulator and encoder to modulate and encode signals sent by said emulated non-SDMA base stations to said plurality of user terminals.

14. The apparatus of claim 10, wherein said means for emulating multiple co-located non-SDMA base stations determines whether it is suitable for using SDMA for said plurality of user terminals to access said wireless communication network.

15. A wireless network, comprising:
a plurality of wireless user terminals including at least one user terminal that does not support SDMA protocols; and
a plurality of base stations, each communicating with one or more of said plurality of wireless user terminals, at least one of said plurality of base stations is an SDMA base station;
wherein said SDMA base station emulates multiple co-located non-SDMA base stations and schedules different communication channels for different emulated non-SDMA base stations to avoid overlapping among said emulated non-SDMA base stations.

16. The wireless network of claim 15, wherein said SDMA base station comprises:
a multi-channel receiver to receive a first set of signals from a plurality of user terminals and to perform at least one of amplification, down-sampling, or analog-to-digital conversion of the first set of signals;
means for emulating multiple co-located non-SDMA base stations, each emulated non-SDMA base station communicating with one or more of said plurality of user terminals in the substantially same way as a conventional non-SDMA base station communicates with the one or more of said plurality of user terminals, each emulated non-SDMA base station processing signals derived from the first said of signals; and
a multi-channel transmitter to transmit a second set of signals to said plurality of user terminals, the second set of signals including signals sent by said emulated non-SDMA base stations to said plurality of user terminals.

17. The wireless network of claim 16, wherein said means for emulating multiple co-located non-SDMA base stations comprises:
de-multiplexing means for spatially de-multiplexing the first set of signals;
and
multiplexing means for spatially multiplexing signals that said emulated non-SDMA base stations send to said plurality of user terminals to produce the second set of signals.

18. The wireless network of claim 17, wherein said means for emulating multiple co-located non-SDMA base stations schedules communication channels for different emulated non-SDMA base stations in at least one of different domains, said domains including time domain, frequency domain, and code domain.

19. The wireless network of claim 17, further comprising:
a signal demodulator and decoder to demodulate and decode said de-multiplexed signals;
processing means for processing messages received from said plurality of user terminals and messages sent to said plurality of user terminals by said emulated non-SDMA base stations; and
a signal modulator and encoder to modulate and encode signals sent by said emulated non-SDMA base stations to said plurality of user terminals.

20. The wireless network of claim 16, wherein said means for emulating multiple co-located non-SDMA base stations determines whether it is suitable for using SDMA for said plurality of user terminals to access said wireless communication network.
